(19) United States
(12) Patent Application Publication
(10) Pub. No.: US 2015/0333981 A1
(43) Pub. Date: Nov. 19, 2015

(54) INFORMATION PROCESSING APPARATUS AND REPORT GENERATING METHOD

(71) Applicant: Takayuki ONO, Tokyo (JP)

(72) Inventor: Takayuki ONO, Tokyo (JP)

(21) Appl. No.: 14/693,058

(22) Filed: Apr. 22, 2015

(30) Foreign Application Priority Data
May 14, 2014 (JP) 2014-100894

(51) Int. Cl. H04L 12/26

(52) U.S. Cl. CPC H04L 43/04; H04L 43/06

(57) ABSTRACT

An information processing apparatus includes: a software information acquiring unit that acquires, from a terminal device, software information on software running on the terminal device; a specifying unit that specifies region information on a region to which a user using the terminal device belongs, on the basis of the software information; a device management information acquiring unit that acquires device management information on usage of a device; a generating unit that generates a report on the basis of the region information and the device management information; and an output unit that outputs the report to the terminal device.

### CROSS-REFERENCE TO RELATED APPLICATIONS

The present application claims priority to and incorporates by reference the entire contents of Japanese Patent Application No. 2014-100894 filed in Japan on May 14, 2014.

### BACKGROUND OF THE INVENTION

1. Field of the Invention

The present invention relates to an information processing apparatus and a report generating method.

2. Description of the Related Art

Conventionally, in the field of managed printing services (MPS), it is common to have a service level agreement (SLA) including terms of guarantee, such as an upper limit of the number of troubles in a device within a certain period, in order to assure a user of the quality of maintenance services on devices.

To realize the terms of guarantee, a device management system that manages device management information, such as usage of a device, or a service desk system that manages service information, such as a malfunction of a device, has been introduced.

For example, Japanese Laid-open Patent Publication No. 2013-131210 discloses a technology for generating and presenting a service report on a network device by taking into account the characteristics of a region to which a user belongs, in order to cope with a case in which a customer who has introduced the MPS is a global company that globally develops a business.

However, in the above described conventional technology, user information and region information are associated with each other in advance, and the region information associated with the user information is used to generate a report in which the characteristics of the region to which the user belongs is taken into account. Therefore, it is difficult to cope with a user whose user information is not registered.

Therefore, it is desirable to provide an information processing apparatus and a report generating method capable of generating a report by taking into account the characteristics of a region to which a user belongs, regardless of whether user information is registered or not.

### SUMMARY OF THE INVENTION

It is an object of the present invention to at least partially solve the problems in the conventional technology.

According to an aspect of the present invention, there is provided an information processing apparatus including: a software information acquiring unit that acquires, from a terminal device, software information on software running on the terminal device; a specifying unit that specifies region information on a region to which a user using the terminal device belongs, on the basis of the software information; a device management information acquiring unit that acquires device management information on usage of a device; a generating unit that generates a report on the basis of the region information and the device management information; and an output unit that outputs the report to the terminal device.

According to another aspect of the present invention, there is provided an information processing apparatus connected to a terminal device via a network, the information processing apparatus including: a network information acquiring unit that acquires, from the terminal device, network information on a location of the terminal device on the network; a specifying unit that specifies region information on a region to which a user using the terminal device is located on the basis of the network information; a device management information acquiring unit that acquires device management information on usage of a device; a generating unit that generates a report on the basis of the region information and the device management information; and an output unit that outputs the report to the terminal device.

According to still another aspect of the present invention, there is provided a report generating method including: acquiring, from a terminal device, software information on software running on the terminal device; specifying region information on a region to which a user using the terminal device belongs, on the basis of the software information; acquiring device management information on usage of a device; generating a report on the basis of the region information and the device management information; and outputting the report to the terminal device.

According to still another aspect of the present invention, there is provided a report generating method including: acquiring, from a terminal device, network information on a location of the terminal device on a network; specifying region information on a region to which a user using the terminal device is located on the basis of the network information; acquiring device management information on usage of a device; generating a report on the basis of the region information and the device management information; and outputting the report to the terminal device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of a configuration of an information processing system of a first embodiment;

FIG. 2 is a block diagram illustrating an example of a configuration of an information processing apparatus of the first embodiment;

FIG. 3 is a block diagram illustrating an example of a detailed configuration when a collecting unit of the first embodiment collects device management information;

FIG. 4 is a diagram illustrating an example of information stored in a region information storage unit of the first embodiment;

FIG. 5 is a block diagram illustrating an example of a detailed configuration of a generating unit of the first embodiment;

FIG. 6 is a diagram illustrating an example of a localize option of the first embodiment;

FIG. 7 is a diagram illustrating an example of the localize option of the first embodiment;

FIG. 8 is a diagram illustrating an example of a report option of the first embodiment;

FIG. 9 is a diagram illustrating an example of a meter report of the first embodiment;

FIG. 10 is a diagram illustrating an example of the report option of the first embodiment;

FIG. 11 is a diagram illustrating an example of the meter report of the first embodiment;

FIG. 12 is a flowchart illustrating an example of a device management information collection process performed by the information processing system of the first embodiment;

FIG. 13 is a flowchart illustrating an example of a meter report generation process performed by the information processing apparatus of the first embodiment;

FIG. 14 is a flowchart illustrating a detailed example of generation of a meter report by the information processing apparatus of the first embodiment;

FIG. 15 is a block diagram illustrating an example of a detailed configuration of a generating unit of a second embodiment;

FIG. 16 is a diagram illustrating an example of information stored in a region information storage unit of the second embodiment;

FIG. 17 is a flowchart illustrating an example of a meter report generation process performed by an information processing apparatus of the second embodiment; and

FIG. 18 is a diagram illustrating an example of a hardware configuration of the information processing apparatus of each of the embodiments.

### DETAILED DESCRIPTION OF THE PREFERRED EMBODIMENTS

Exemplary embodiments of an information processing apparatus, an information processing system, a report generating method, and a program according to the present embodiments will be described in detail below with reference to the accompanying drawings.

### First Embodiment

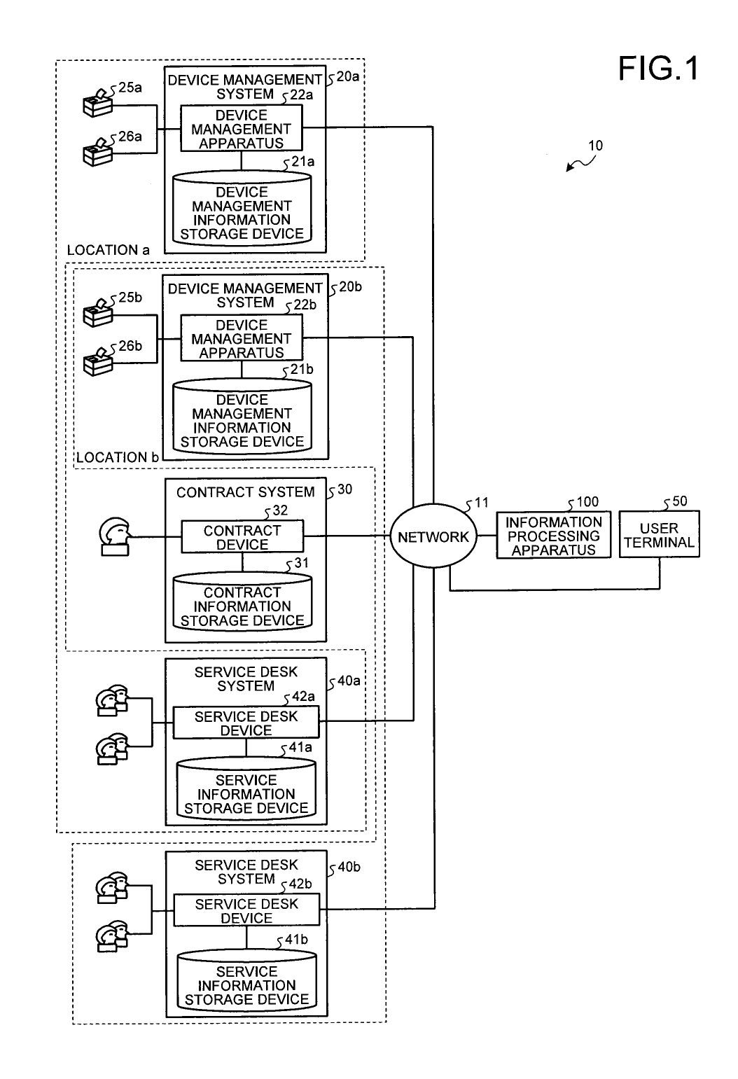

FIG. 1 is a block diagram illustrating an example of a configuration of an information processing system 10 of a first embodiment. As illustrated in FIG. 1, the information processing system 10 includes device management systems 20a and 20b, a contract system 30, service desk systems 40a and 40b, a user terminal 50 (an example of a terminal device), and an information processing apparatus 100.

It is assumed that the device management system 20a and the service desk system 40a are installed in a location a, and the device management system 20b and the service desk system 40b are installed in a location b. The locations a and b are locations for the same customer. In the first embodiment, it is assumed that the locations a and b are in the same region; however, it is not limited thereto. The locations a and b may be in different regions. The region is a concept including a country. In the example illustrated in FIG. 1, a case will be described in which the two device management systems and the two service desk systems are provided; however, it is not limited thereto. The numbers of the device management systems and the service desk systems may be arbitrary as long as the numbers are more than one.

The device management systems 20a and 20b, the contract system 30, the service desk systems 40a and 40b, the user terminal 50, and the information processing apparatus 100 are connected to one another via a network 11. The network 11 is realized by, for example, a public communication line, a specific communication line (dedicated line), or the like.

The device management system 20a is a database system that manages device management information on usage of an image forming device, such as a printer, a copier, a multifunction peripheral, or a facsimile machine, installed in the location a. The multifunction peripheral has at least two of a copying function, a printing function, a scanner function, and a facsimile function.

In the example in FIG. 1, only printers 25a and 26a are illustrated as examples of the image forming devices installed in the location a; however, the image forming devices managed by the device management system 20a are not limited thereto. Further, in the first embodiment, an example will be described in which the device management systems 20a and 20b manage the image forming devices; however, the device to be managed is not limited to this example. For example, the device may be any device, such as a terminal device including a personal computer (PC) and the like, or any of various electronic devices including a projector, a camera, an air conditioner, a refrigerator, a fluorescent light, an automatic vending machine, a handheld terminal, and the like, as long as the device management information can be acquired from the device.

Furthermore, in the first embodiment, an example will be described in which the device management information includes device information for identifying an image forming device and the number of outputs (prints) of the image forming device; however, it is not limited thereto. Moreover, the device information in the device management information is a combination of a manufacturer name, a model name, and a serial number; however, it is not limited thereto.

The device management system 20a includes a device management information storage device 21a and a device management apparatus 22a.

The device management information storage device 21a is a database, in which the device management information acquired by the device management apparatus 22a to be described later is accumulated. In the first embodiment, the device management information storage device 21a stores therein the device information and the number of outputs on each of the image forming devices managed by the device management system 20a, in an associated manner.

The device management apparatus 22a is a normal computer, such as a server device, periodically (for example, for every one hour) acquires the device management information from each of the image forming devices managed by the device management system 20a, and registers the device management information in the device management information storage device 21a. In the first embodiment, the device management apparatus 22a periodically acquires the device information and the number of outputs from each of the image forming devices managed by the device management system 20a, and every time the device information and the number of outputs are acquired, registers, in the device management information storage device 21a, the acquired number of outputs in association with device information in the device management information storage device 21a corresponding to the acquired device information.

The device management system 20b is a database system that manages device management information on an image forming device installed in the location b. However, the device management system 20b is a database system of a different type from the device management system 20a such that at least a type of a data source differs from that of the device management system 20a. Examples of the type of the data source include MySQL, Oracle, and MSSQL. In the example illustrated in FIG. 1, only printers 25b and 26b are illustrated as example of the image forming devices installed in the location b; however, the image forming devices managed by the device management system 20b are not limited thereto.

The device management system 20b includes a device management information storage device 21b and a device management apparatus 22b.

The device management information storage device 21b is a database, in which the device management information acquired by the device management apparatus 22b to be described later is accumulated. In the first embodiment, the device management information storage device 21b stores therein the device information and the number of outputs on each of the image forming devices managed by the device management system 20b, in an associated manner.

The device management apparatus 22b is a normal computer, such as a server device, periodically acquires the device management information from each of the image forming devices managed by the device management system 20b, and registers the device management information in the device management information storage device 21b. In the first embodiment, the device management apparatus 22b periodically (for example, for every one hour) acquires the device information and the number of outputs from each of the image forming devices managed by the device management system 20b, and every time the device information and the number of outputs are acquired, registers, in the device management information storage device 21b, the acquired number of outputs in association with device information in the device management information storage device 21b corresponding to the acquired device information.

As described above, in the first embodiment, the device management systems 20a and 20b acquire and manage the device management information on a one-hour basis, for example. Therefore, the device management information of the first embodiment indicates the usage of an image forming device, which is a management object, for each day and each time.

The contract system 30 is a database system that manages contract information on quality assurance for each device. In the first embodiment, it is assumed that a service level agreement (SLA) is made between a carrier of the information processing system 10 and a customer of the locations a and b, where the SLA includes, in the terms of guarantee, an upper limit of the number of device malfunctions within a predetermined period for each device malfunction type of each of the devices installed in the locations a and b.

Therefore, in the first embodiment, an example will be described in which the contract information includes the upper limit of the number of device malfunctions within a predetermined period for each device malfunction type of each of the devices installed in the locations a and b; however, it is not limited thereto. For example, if the SLA includes, in the terms of guarantee, an upper limit of time for arrival of a service person, a minimum operating rate in a predetermined period, or an upper limit of time for recovery from a device malfunction, the contract information may include any of them. Incidentally, the contract system 30 manages not only the contract information on the customer of the locations a and b, but also contract information on other customers.

The contract system 30 includes a contract information storage device 31 and a contract device 32. The contract information storage device 31 is a database that stores therein the contract information input to the contract device 32 to be described later, and stores therein the contract information for each customer ID for identifying a customer, in an associated manner. The contract device 32 is a normal computer, such as a server device, and receives the customer ID and the contract information that are input to the contract device 32 by a salesperson or the like of the carrier of the information processing system 10 by using an input device (not illustrated). The contract device 32 registers the input contract information in the contract information storage device 31 in association with a customer ID in the contract information storage device 31 corresponding to the input customer ID.

The service desk system 40a is a database system that manages service information on a device malfunction of each of the image forming devices installed in the location a. The image forming devices managed by the service desk system 40a are not limited to the printers 25a and 26a, similarly to the device management system 20a.

In the first embodiment, an example will be described in which the service information includes device information for identifying an image forming device and the number of device malfunctions of the image forming device for each device malfunction type; however, it is not limited thereto. It is sufficient that the service information is information on a device malfunction and corresponds to the contract information. Therefore, the service information may include a time of arrival of a service person, an operating rate, a time of recovery from a device malfunction, or the like, for example. Further, it is assumed that the device information in the service information is a serial number; however, it is not limited thereto.

The service desk system 40a includes a service information storage device 41a and a service desk device 42a.

The service information storage device 41a is a database, in which the service information based on the content of a device malfunction input by the service desk device 42a to be described later is accumulated. In the first embodiment, the service information storage device 41a stores therein the device information on each of the image forming devices managed by the service desk system 40a, the number of device malfunctions for each device malfunction type, and a device malfunction content, in an associated manner. Examples of the device malfunction content includes a device malfunction type, a date and time of occurrence of a device malfunction, and a way of dealing with a device malfunction.

The service desk device 42a is a normal computer, such as a server device. The service desk device 42a registers the service information, which is based on a device malfunction content of each of the image forming devices managed by the service desk system 40a and which is input to the service desk device 42a by a person responsible for the service desk system 40a or by a service engineer by using an input device (not illustrated), in the service information storage device 41a.

In the first embodiment, the service desk device 42a receives input of the device information on and a device malfunction content of each of the image forming devices managed by the service desk system 40a. The service desk device 42a updates the number of device malfunctions of a device malfunction type, which is associated with device information in the service information storage device 41a corresponding to the input device information and which is related to the input device malfunction content, and registers the input device malfunction content in the service information storage device 41a in association with the device information.

The service desk system 40b is a database system that manages service information on each of the image forming devices installed in the location b. However, the service desk system 40b is a database system of a different type from the service desk system 40a such that at least a type of a data source differs from that of the service desk system 40a. The image forming devices managed by the service desk system 40b are not limited to the printers 25b and 26b, similarly to the device management system 20b.

The service desk system 40b includes a service information storage device 41b and a service desk device 42b.

The service information storage device 41b is a database, in which the service information based on the content of a device malfunction input by the service desk device 42b to be described later is stored. In the first embodiment, the service information storage device 41b stores therein the device information on each of the image forming devices managed by the service desk system 40b, the number of device malfunctions for each device malfunction type, and a device malfunction content, in an associated manner.

The service desk device 42b is a normal computer, such as a server device. The service desk device 42b registers the service information, which is based on a device malfunction content of each of the image forming devices managed by the service desk system 40b and which is input to the service desk device 42b by a person responsible for the service desk system 40b or by a service engineer by using an input device (not illustrated), in the service information storage device 41b.

In the first embodiment, the service desk device 42b receives input of the device information on and a device malfunction content of each of the image forming devices managed by the service desk system 40b. The service desk device 42b updates the number of device malfunctions of a device malfunction type, which is associated with device information in the service information storage device 41b corresponding to the input device information and which is related to the input device malfunction content, and registers the input device malfunction content in the service information storage device 41b in association with the device information.

As described above, in the service desk systems 40a and 40b, the service information is basically registered by hand; therefore, to simplify the registration (input), only a serial number serves as the device information. In contrast, in the device management systems 20a and 20b, registration of the device management information is automated and there is little need to simplify the registration; therefore, a combination of a manufacturer name, a model name, and a serial number serves as the device information.

The user terminal 50 is a terminal device of a customer, and may be a desktop PC, a notebook PC, a tablet terminal, a smartphone, or the like, for example. The user terminal 50 requests the information processing apparatus 100 to generate a report on a browser displayed on a display device (not illustrated). The user terminal 50 acquires the report generated by the information processing apparatus 100, and displays the acquired report on the browser.

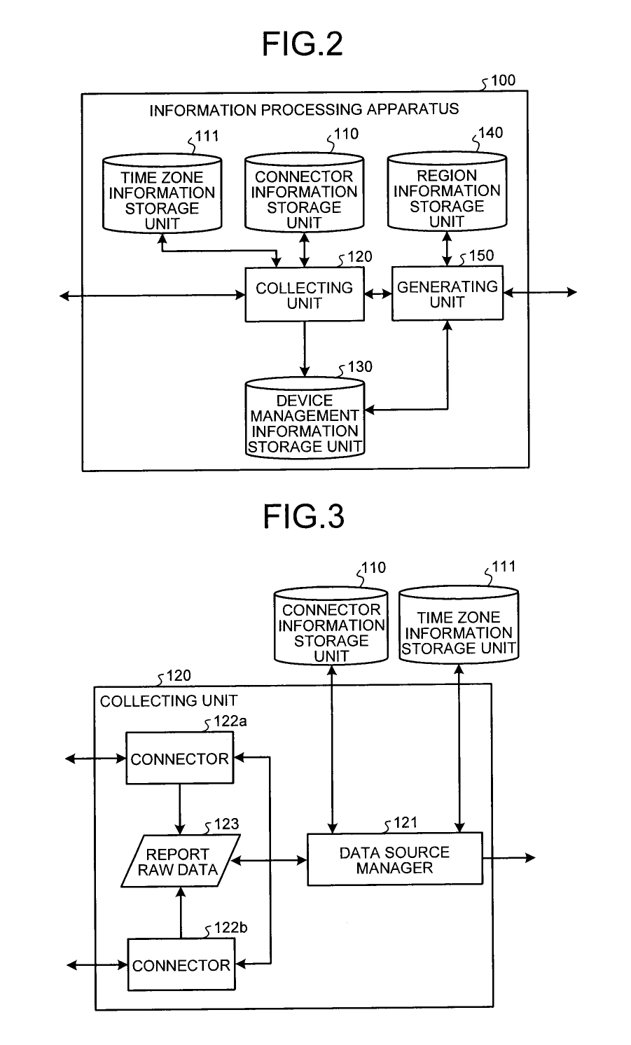

The information processing apparatus 100 is a server device that generates a report on an image forming device installed in the locations a and b in response to a request from the user terminal 50. FIG. 2 is a block diagram illustrating an example of a configuration of the information processing apparatus 100 of the first embodiment. As illustrated in FIG. 2, the information processing apparatus 100 includes a connector information storage unit 110, a time zone information storage unit 111, a collecting unit 120, a device management information storage unit 130, a region information storage unit 140, and a generating unit 150.

The connector information storage unit 110, the time zone information storage unit 111, the device management information storage unit 130, and the region information storage unit 140 are realized by, for example, at least any of a magnetic storage device, an optical storage device, and an electrical storage device, such as a hard disk drive (HDD), a solid state drive (SSD), a memory card, an optical disk/magnetic disk, a read only memory (ROM), or a random access memory (RAM). The collecting unit 120 and the generating unit 150 are realized by a control device, such as a central processing unit (CPU).

The connector information storage unit 110 stores therein information on a connector generated in the collecting unit 120 to be described later. For example, the connector information storage unit 110 stores therein a table, in which a location ID for identifying a location of a customer is associated with a connector name of a connector corresponding to the data source of the database system (the device management system and the service desk system) introduced in the location of the customer. Details of the connector will be described later.

The time zone information storage unit 111 stores therein information on a time zone. For example, the time zone information storage unit 111 stores therein a table, in which a location ID of a customer is associated with time zone information indicating a time zone of a region including the location of the customer indicated by the location ID. In the first embodiment, the time zone is represented by a difference from universal time coordinated (UTC).

The collecting unit 120 collects the device management information from each of the device management systems 20a and 20b, collects the contract information from the contract system 30, and collects the service information from each of the service desk systems 40a and 40b.

The collecting unit 120, when collecting the device management information from each of the device management systems 20a and 20b, sends an acquisition request corresponding to a type of the device management system to each of the device management systems 20a and 20b, and collects the device management information from each of the device management systems 20a and 20b. Then, the collecting unit 120 converts each of the collected device management information into a device management information common format, and stores each of the device management information in the device management information storage unit 130.

Specifically, the collecting unit 120 transmits a query corresponding to a type of the database to each of the device management systems 20a and 20b, and collects the device management information from each of the device management systems 20a and 20b. Then, the collecting unit 120 maps each of the collected device management information to a device management information common object for conversion into the device management information common format, and stores each of the device management information in the device management information storage unit 130.

FIG. 3 is a block diagram illustrating an example of a detailed configuration when the collecting unit 120 of the first embodiment collects the device management information. As illustrated in FIG. 3, the collecting unit 120 includes a data source manager 121 and connectors 122a and 122b.

The data source manager 121, at a timing to collect the device management information, acquires a connector name associated with a location ID indicating a location of a collection site from the connector information storage unit 110, and generates a connector corresponding to the acquired connector name by reflection.

In the first embodiment, the data source manager 121 generates the connector 122a from a connector name associated with the location ID of the location a, and generates the connector 122b from a connector name associated with the location ID of the location b. Incidentally, the connector 122a corresponds to the data source of the device management system 20a in the location a, and the connector 122b corresponds to the data source of the device management system 20b in the location b.

The data source manager 121 stores report raw data 123 generated by the connectors 122a and 122b in the device management information storage unit 130. In the first embodiment, every time the connectors 122a and 122b generate the report raw data 123, the data source manager 121 acquires, from the time zone information storage unit 111, time zone information associated with the location ID indicating a location of a collection site of the device management information. For example, when the connector 122a generates the report raw data 123, the data source manager 121 acquires time zone information associated with the location ID indicating the location a from the time zone information storage unit 111, and when the connector 122b generates the report raw data 123, the data source manager 121 acquires time zone information associated with the location ID indicating the location b from the time zone information storage unit 111. Meanwhile, it is assumed that the locations a and b are in China, and the time zone information acquired by the data source manager 121 indicates the China time zone (UTC+8); however, it is not limited thereto. The data source manager 121 registers the generated report raw data 123 and the acquired time zone information in the device management information storage unit 130 in an associated manner.

Each of the connectors 122a and 122b generates and transmits a query, which corresponds to a type of the data source or a definition of the table and which is a request for acquisition of the device management information, with respect to the data source of each of the device management systems 20a and 20b. Each of the connectors 122a and 122b acquires, as the device management information, the device information (a combination of a manufacturer name, a model name, and a serial number) and the number of outputs.

The report raw data 123 will be described blow. The report raw data 123 is a common object generated by the connectors 122a and 122b, and contains information, such as a manufacturer name (Manufacture), a model name (Model), a serial number (Serial Number), and the number of outputs (Counter), in own fields. At least the number of outputs (Counter) in the report raw data 123 is represented by numerical data, and the manufacturer name (Manufacture), the model name (Model), and the serial number (Serial Number) are represented by either of numerical data or text data.

Each of the connectors 122a and 122b generates an instance of the report raw data 123 from the device information and the number of outputs acquired as above, and maps the generated instance to a list of the report raw data 123 in accordance with the fields. Consequently, the report raw data 123 is generated.

Referring back to FIG. 2, when collecting the contract information from the contract system 30, the collecting unit 120 sends an acquisition request to the contract system 30 and collects the contract information. Specifically, the collecting unit 120 transmits a query corresponding to a type of the database to the contract system 30, and collects the contract information from the contract system 30.

When collecting the service information from each of the service desk systems 40a and 40b, the collecting unit 120 sends an acquisition request corresponding to a type of the service desk system to each of the service desk systems 40a and 40b, and collects the service information from each of the service desk systems 40a and 40b. Then, the collecting unit 120 converts each of the collected service information into a service information common format.

Specifically, the collecting unit 120 transmits a query corresponding to a type of the database to each of the service desk systems 40a and 40b, and collects the service information from each of the service desk systems 40a and 40b. Then, the collecting unit 120 maps each of the collected service information to a service information common object for conversion into the service information common format.

For example, when the data source manager 121 of the collecting unit 120 receives, from the generating unit 150 to be described later, an instruction to collect the contract information and the service information, and at the timing of collecting the contract information and the service information, the data source manager 121 generates a connector corresponding to each of the contract system 30 and the service desk systems 40a and 40b, similarly to the case of collecting the device management information.

Each of the connectors generates and transmits a query, which corresponds to a type of the data source or a definition of the table and which is a request for acquisition of the contract information or the service information, with respect to the data source of the corresponding system, and acquires the contract information or the service information. The contract information corresponds to, for example, an upper limit of the number of device malfunctions within a predetermined period for each device malfunction type of each of the devices installed in the locations a and b. The service information corresponds to, for example, the device information (serial number) and the number of device malfunctions for each device malfunction type.

Each of the connectors corresponding to the service desk systems 40a and 40b generates an instance of the service information common object from the acquired service information, and maps the generated instance to a list of the service information common object in accordance with the fields. Consequently, the service information common object is generated.

Each of the connectors sends the contract information or the service information common object to the data source manager 121. The data source manager 121 sends, to the generating unit 150 to be described later, the contract information and the service information common object sent from each of the connectors.

The device management information storage unit 130 stores therein the device management information, which is collected by the collecting unit 120 and converted into the device management information common format. Specifically, the device management information storage unit 130 stores therein the report raw data 123 generated by the collecting unit 120. In the first embodiment, the device management information storage unit 130 stores therein the time zone information indicating a time zone of a region including the locations a and b, and the report raw data 123 generated by the collecting unit 120, in an associated manner.

The region information storage unit 140 stores therein information on a region. In the first embodiment, it is assumed that the region information storage unit 140 stores therein region identification information for identifying a region, language information indicating a language used in the region, font information indicating a font of the language indicated by the language information, and currency information indicating a currency used in the region, in an associated manner; however, it is not limited thereto.

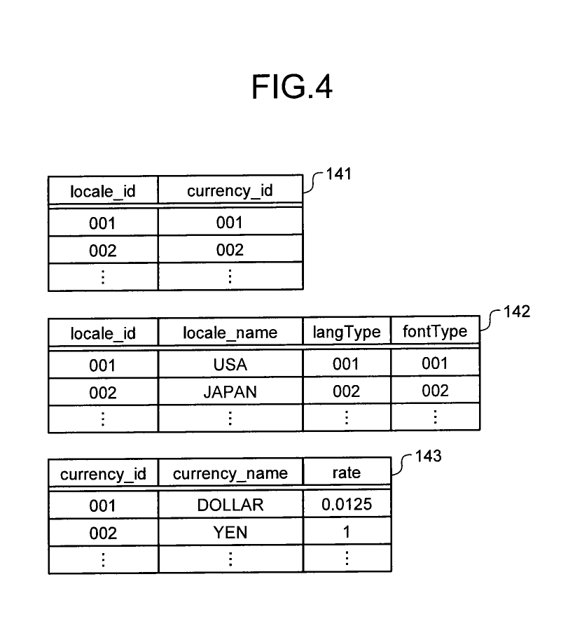

FIG. 4 is a diagram illustrating an example of information stored in the region information storage unit 140 of the first embodiment. In the example illustrated in FIG. 4, the region information storage unit 140 stores therein a main table 141, a locale table 142, and a currency table 143.

The main table 141 is a table containing, for each region, a locale_id indicating an ID of local information on the region and a currency_id indicating an ID of currency information on the region, in an associated manner.

The locale table 142 is a table containing a locale_id indicating the ID of the locale information, a locale_name (an example of the region identification information) indicating a region (country) name, a langType (an example of the language information) indicating a language used in the region, and a fontType (an example of the font information) indicating a font of the language, in an associated manner. In the example illustrated in FIG. 4, langType is set such that a language of “001” represents English and a language of “002” represents Japanese, and fontType is set such that a font of “001” represents Century and a font of “002” represents MS Gothic.

The currency table 143 is a table containing a currency_id indicating an ID of the currency information, a currency_name (an example of the currency information) indicating a currency name, and a rate (an example of the currency information) indicating a rate of the currency, in an associated manner. In the example illustrated in FIG. 4, the rate of a currency is represented by a rate to Japanese yen (YEN), and an exchange rate of US dollar (DOLLAR) to Japanese yen is assumed as 1 dollar=80 yen.

In the example illustrated in FIG. 4, the main table 141 and the locale table 142 are associated with each other by the locale_id, and the main table 141 and the currency table 143 are associated with each other by the currency_id.

Referring back to FIG. 2, the generating unit 150 acquires software information on software running on the user terminal 50, from the user terminal 50 that has requested generation of a report, and specifies region information on a region to which a user using the user terminal 50 belongs on the basis of the acquired software information. Further, the generating unit 150 acquires the device management information from the device management information storage unit 130, and generates a report on the basis of the acquired device management information and the specified region information. Furthermore, the generating unit 150 outputs the generated report to the user terminal 50.

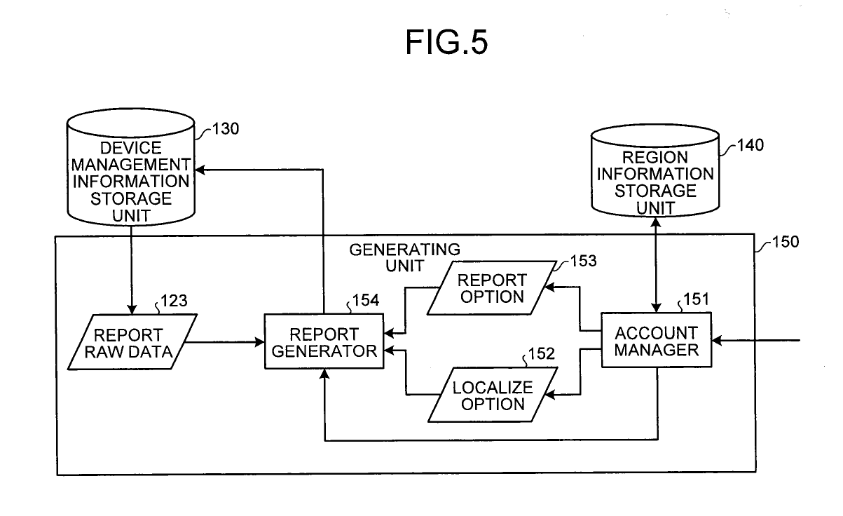

FIG. 5 is a block diagram illustrating an example of a detailed configuration of the generating unit 150 of the first embodiment. As illustrated in FIG. 5, the generating unit 150 includes an account manager 151 (an example of a generation request receiving unit, a period receiving unit, a software information acquiring unit, a specifying unit, and an output unit) and a report generator 154 (an example of a device management information acquiring unit and a generating unit).

The account manager 151 receives a report generation request from the user terminal 50, acquires basic information on a report, such as display items of the report, from the generation request, and employs the acquired information as a report option 153. Then, the account manager 151 instructs the report generator 154 to generate the report.

Specifically, the account manager 151 receives, from the user terminal 50, a generation request corresponding to a type of a report to be generated. Examples of the type of the report include a meter report related to the maintenance/management cost of a device (total cost of ownership (TOC)) as an example of the cost related to the device, an SLA report that reflects whether the service information complies with the contract information, and an integrated report in which the above reports are integrated. For example, the account manager 151 receives, from the user terminal 50, a meter report generation request containing the device information, a TCO value, and a period for calculating the TCO value as the basic information on the report. Then, the account manager 151 instructs the report generator 154 to generate a report of the requested type.

Further, the account manager 151 acquires, from the user terminal 50 that has sent the generation request, software information on software running on the user terminal 50. In the first embodiment, an example will be described in which the software is an operating system (OS) running on the user terminal 50 and the software information is system information on the OS; however, it is not limited thereto. For example, the software may be a browser running on the user terminal 50, and the software information may be system information on the browser.

The account manager 151, upon acquiring the software information, specifies the region identification information, the language information, and the time zone information indicating a time zone of a region indicated by the region identification information, by using the software information. Specifically, because the software information contains the region identification information set in the software, the language information, and the time zone information indicating a time zone of the region indicated by the region identification information, the account manager 151 can specify the region identification information, the language information, and the time zone information by extracting the above information from the software information.

Further, the account manager 151, by referring to the region information storage unit 140, specifies currency information associated with the specified region identification information, and specifies font information associated with the specified language information. Specifically, the account manager 151 generates a query to acquire the currency information on the region indicated by the region identification information and to acquire the font information on the language indicated by the language information, by using the specified region identification information and the specified language information, issues the query to the region information storage unit 140, and specifies (acquires) the currency information and the font information.

Then, the account manager 151 employs the region information containing the region identification information, the language information, the time zone information, the currency information, and the font information that are specified as above, as the region information on the region to which the user using the user terminal 50 belongs, and employs the region information as a localize option 152.

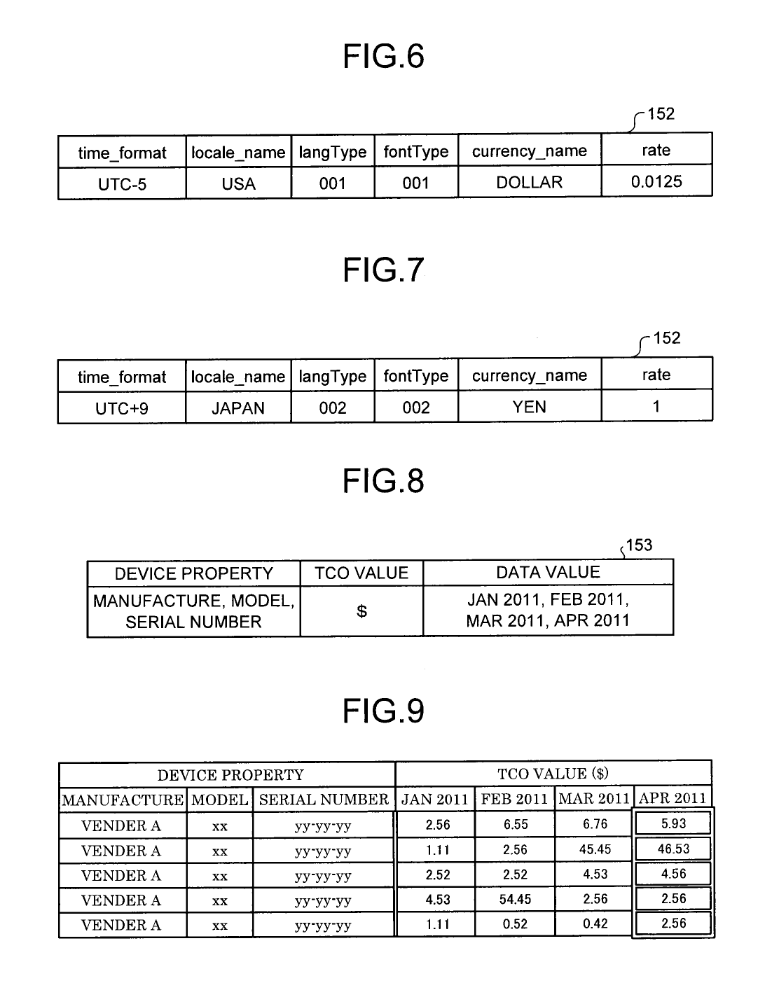

For example, it is assumed that the region information storage unit 140 stores therein the tables as illustrated in FIG. 4, and the account manager 151 specifies a region name of “USA”, a language of “001 (English)”, and a time zone of “UTC-5” from the software information acquired from the user terminal 50. In this case, the account manager 151 issues a query generated by using the region name of “USA” and the language of “001 (English)” to the region information storage unit 140, and specifies (acquires) a currency name of “DOLLAR”, a rate of “0.0125”, and a font of “001 (Century)”. Then, the account manager 151 employs the region information containing the specified information as the localize option 152 as illustrated in FIG. 6.

For another example, it is assumed that the region information storage unit 140 stores therein the tables as illustrated in FIG. 4, and the account manager 151 specifies a region name of “JAPAN”, a language of “002 (Japanese)”, and a time zone of “UTC+9” from the software information acquired from the user terminal 50. In this case, the account manager 151 issues a query generated by using the region name of “JAPAN” and the language of “002 (Japanese)” to the region information storage unit 140, and specifies (acquires) a currency name of “YEN”, a rate of “1”, and a font of “002 (MS Gothic)”. Then, the account manager 151 employs the region information containing the specified information as the localize option 152 as illustrated in FIG. 7.

The report generator 154, upon receiving an instruction to generate a report from the account manager 151, generates a report localized for the region indicated by the localize option 152 by using the localize option 152, the report option 153, and the like obtained by the account manager 151, and outputs the report to the user terminal 50. The report localized for the region indicated by the localize option 152 is a report targeted to (corresponding to) users belonging to the region indicated by the localize option 152, in particular, a report in which the contents of the report option 153 and the report raw data 123 are configured in accordance with the region information contained in the localize option 152.

Specifically, the report generator 154, upon receiving an instruction to generate a meter report from the account manager 151, acquires the report raw data 123 from the device management information storage unit 130. Then, the report generator 154 generates a meter report localized for the region indicated by the localize option 152 by using the localize option 152, the report option 153, and the report raw data 123, and outputs the meter report to the user terminal 50.

For example, it is assumed that the localize option 152 contains a time zone of “UTC-5”, a region name of “USA”, a language of “001 (English)”, a font of “001 (century)”, a currency name of “DOLLAR”, and a rate of “0.0125” (see FIG. 6), and the report option 153 contains device information, a TCO value, and a period of January 2011 to April 2011 as a period for calculating the TCO value. Meanwhile, the description language of the report option 153 may be any language; however, in this example, the description language is assumed as English. Specifically, the report option 153 is represented by text data, and contains a Device Property (Manufacture, Model, Serial Number), a TCO value ($), and a Data value (January 2011, February 2011, March 2011, April 2011) of the TCO value as illustrated in FIG. 8. Further, as described earlier, it is assumed that the locations a and b are in China, and the device management information storage unit 130 stores therein the time information indicating the China time zone (UTC+8) and the report raw data 123 in an associated manner.

In this case, the report generator 154 generates a meter report as illustrated in FIG. 9.

More specifically, because the localize option 152 indicates that the language is English and the font is Century, the report generator 154 determines that the report option 153 is written in English in the Century font and contains a Device Property (Manufacture, Model, Serial Number) and a TCO value ($) (January 2011, February 2011, March 2011, April 2011). Meanwhile, the report generator 154 uses the report option 153 as it is because the report option 153 is written in English as described above with reference to FIG. 8. However, if the report option 153 is written in a language other than English, the report generator 154 translates the contents of the report option 153 into English.

Further, the report generator 154 calculates a time difference of +13 hours from the time zone of UTC-5 in the localize option 152 and the time zone of UTC+8 indicated by the time zone information in the device management information storage unit 130.

Then, the report generator 154 corrects the period of January 2011 to April 2011 to a period of Jan. 1, 2011 at 13:00 o'clock to May 1, 2011 at 13 o'clock, and acquires the report raw data 123 corresponding to the period of Jan. 1, 2011 at 13:00 o'clock to May 1, 2011 at 13 o'clock from the device management information storage unit 130.

Further, the report generator 154 adds the numbers of outputs in the report raw data 123 within the period from Jan. 1, 2011 at 13 o'clock to Feb. 1, 2011 at 13 o'clock for each device to obtain the number of outputs for January 2011, and multiplies the obtained number of outputs by the rate of 0.0125 as the rate to DOLLAR in the localize option 152 to calculate a dollar-converted TCO value for January 2011. The report generator 154 calculates TCO values for February 2011, March 2011, and April 2011 in the same manner. Consequently, the numbers of outputs in the report raw data 123 are converted to dollar-converted values, so that costs for the device are calculated in dollars. Further, the report generator 154 writes the contents represented by text data in the report raw data 123 in English in the Century font.

Lastly, the report generator 154 writes the device information and the calculated TCO value in the report raw data 123 in accordance with the display items written in English, and generates the meter report as illustrated in FIG. 9.

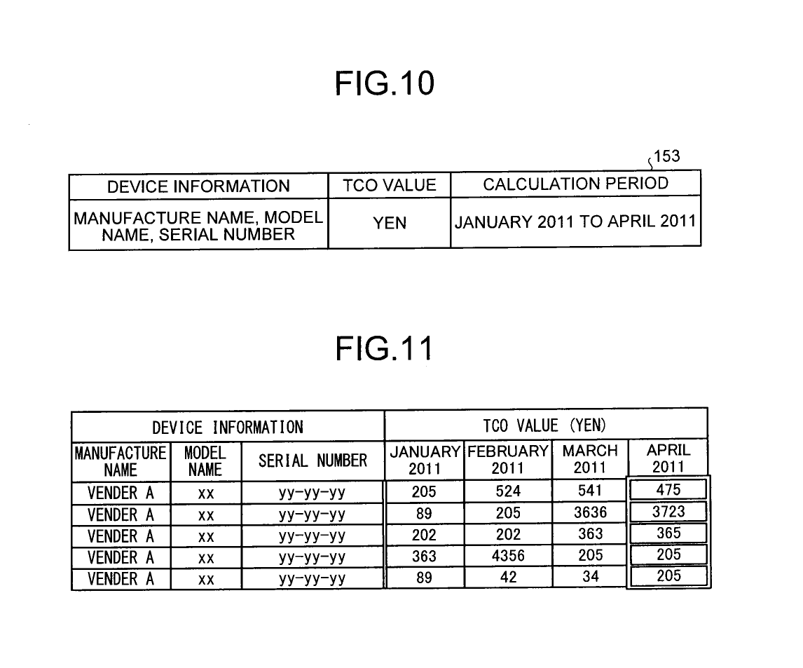

For another example, it is assumed that the localize option 152 contains a time zone of “UTC+9”, a region name of “JAPAN”, a language of “002 (Japanese)”, a font of “002 (MS Gothic)”, a currency name of “YEN”, and a rate of “1” (see FIG. 7), and the report option 153 contains device information, a TCO value, and a period of January 2011 to April 2011 as a period for calculating the TCO value. It is assumed that the report option 153 is written in Japanese. Specifically, the report option 153 is represented by text data, and contains device information (a manufacturer name, a model name, and a serial number), a TCO value (yen), and a period for calculating the TCO value (January 2011 to April 2011) as illustrated in FIG. 10. Further, it is assumed that the locations a and b are in China, and the device management information storage unit 130 stores therein the time information indicating the China time zone (UTC+8) and the report raw data 123 in an associated manner.

In this case, the report generator 154 generates a meter report as illustrated in FIG. 11.

More specifically, because the localize option 152 indicates that the language is Japanese and the font is MS Gothic, the report generator 154 determines that the report option 153 is written in Japanese in the MS Gothic font, and contains a Device Property (Manufacture, Model, Serial Number) and a TCO value ($) (January 2011, February 2011, March 2011, April 2011). Meanwhile, the report generator 154 uses the report option 153 as it is because the report option 153 is written in Japanese as described above with reference to FIG. 10. However, if the report option 153 is written in a language other than Japanese, the report generator 154 translates the contents of the report option 153 into Japanese.

Further, the report generator 154 calculates a time difference of −1 hour from the time zone of UTC+9 in the localize option 152 and the time zone of UTC+8 indicated by the time zone information in the device management information storage unit 130.

Then, the report generator 154 corrects the period of January 2011 to April 2011 to a period of Dec. 31, 2010 at 23:00 o'clock to Apr. 30, 2011 at 23 o'clock, and acquires the report raw data 123 corresponding to the period from Dec. 31, 2010 at 23:00 o'clock to Apr. 30, 2011 at 23 o'clock from the device management information storage unit 130.

Further, the report generator 154 adds the numbers of outputs in the report raw data 123 within the period from Dec. 31, 2010 at 23:00 o'clock to Apr. 30, 2011 at 23 o'clock for each device to obtain the number of outputs for January 2011, and multiplies the obtained number of outputs by the rate of 1 as the rate to YEN in the localize option 152 to calculate a yen-converted TCO value for January 2011. The report generator 154 calculates TCO values for February 2011, March 2011, and April 2011 in the same manner. Consequently, the numbers of outputs in the report raw data 123 are converted to yen-converted values, so that costs for the device are calculated in yen. Further, the report generator 154 writes the contents represented by text data in the report raw data 123 in Japanese in the MS Gothic font.

Lastly, the report generator 154 writes the device information and the calculated TCO value in the report raw data 123 in accordance with the display items written in Japanese, and generates the meter report as illustrated in FIG. 11.

Furthermore, the report generator 154, upon receiving an instruction to generate an integrated report from the account manager 151, acquires the report raw data 123 from the device management information storage unit 130, requests the collecting unit 120 to collect the contract information and the service information, and acquires the contract information and a service information common object. Then, the report generator 154 generates a data object in which the report raw data 123 and the service information common object are interconnected (associated) by using the serial number as a key. Furthermore, the report generator 154 generates an integrated report localized for the region indicated by the localize option 152 by using the localize option 152, the report option 153, the data object, and the contract information, and outputs the integrated report to the user terminal 50.

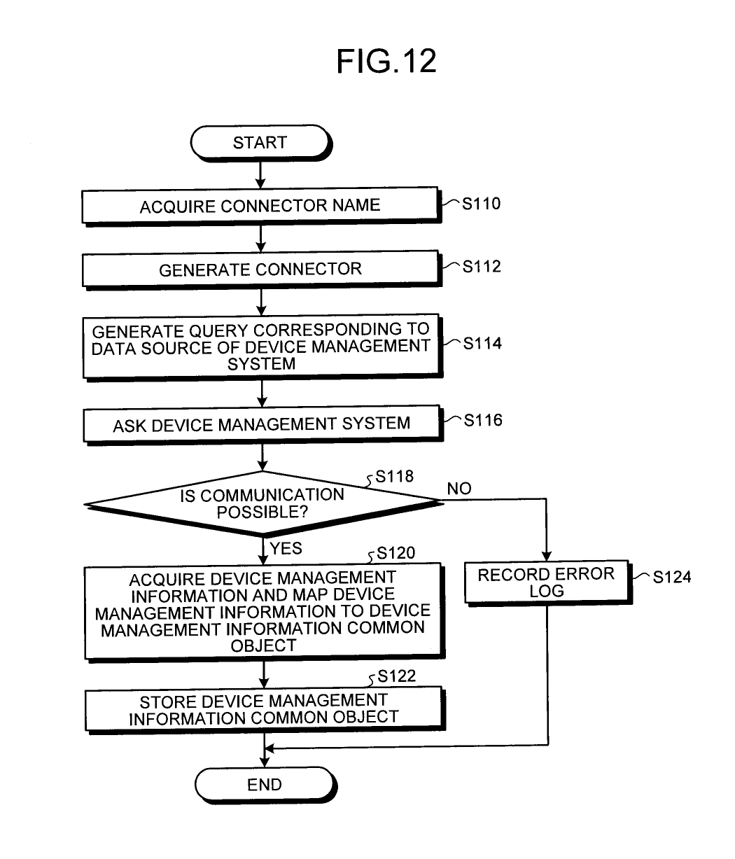

FIG. 12 is a flowchart illustrating an example of a device management information collection process performed by the information processing system 10 of the first embodiment.

First, the data source manager 121, at the timing to collect the device management information, acquires a connector name associated with a location ID indicating a location of a collection site form the connector information storage unit 110 (Step S110).

Subsequently, the data source manager 121 generates a connector corresponding to the acquired connector name by reflection (Step S112). In the first embodiment, the data source manager 121 generates the connector 122a from the connector name associated with the location ID of the location a, and generates the connector 122b from the connector name associated with the location ID of the location b.

Then, each of the connectors 122a and 122b generates a query, which corresponds to a type of the data source or a definition of the table and which is a request for acquisition of the device management information, with respect to the data source of each of the device management systems 20a and 20b (Step S114).

Subsequently, the connectors 122a and 122b transmit the generated query to the device management systems 20a and 20b, respectively, and ask for acquisition of the device management information (Step S116).

Then, if communication with the device management systems 20a and 20b is possible (YES at Step S118), the connectors 122a and 122b acquire the device management information from the device management systems 20a and 20b, respectively, and map the device management information to the device management information common object (the report raw data 123) (Step S120).

Subsequently, the data source manager 121 stores the device management information common object, in which the device management information is mapped, in the device management information storage unit 130 (Step S122).

If communication with the device management systems 20a and 20b is not possible (NO at Step S118), each of the connectors 122a and 122b records an error log (Step S124).

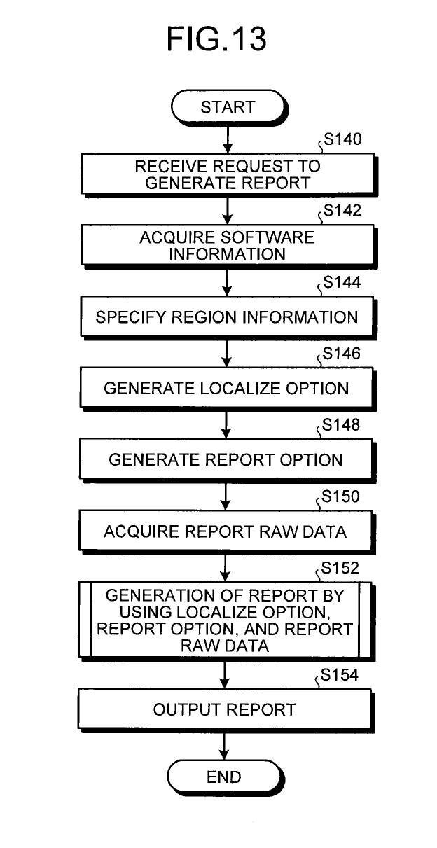

FIG. 13 is a flowchart illustrating an example of a meter report generation process performed by the information processing apparatus 100 of the first embodiment.

First, upon receiving a request to generate a meter report from the user terminal 50 (Step S140), the account manager 151 acquires software information from the user terminal 50 (Step S142).

Subsequently, the account manager 151 specifies region identification information, language information, and time zone information by using the acquired software information, generates a query to acquire currency information on a region indicated by the region identification information and to acquire font information on a language indicated by the language information by using the specified region identification information and the specified language information, issues the query to the region information storage unit 140, and specifies (acquires) the currency information and the font information to specify the region information (Step S144).

Then, the account manager 151 generates the localize option 152 from the specified region information (Step S146).

Subsequently, the account manager 151 acquires basic information on a report, such as display items of the report, from the request to generate a meter report, and generates the report option 153 (Step S148). Then, the account manager 151 instructs the report generator 154 to generate a meter report.

Subsequently, upon receiving an instruction to generate a meter report from the account manager 151, the report generator 154 acquires the report raw data 123 from the device management information storage unit 130 (Step S150).

Then, the report generator 154 generates a meter report localized for the region indicated by the localize option 152 by using the localize option 152, the report option 153, and the report raw data 123 (Step S152), and outputs the meter report to the user terminal 50 (Step S154).

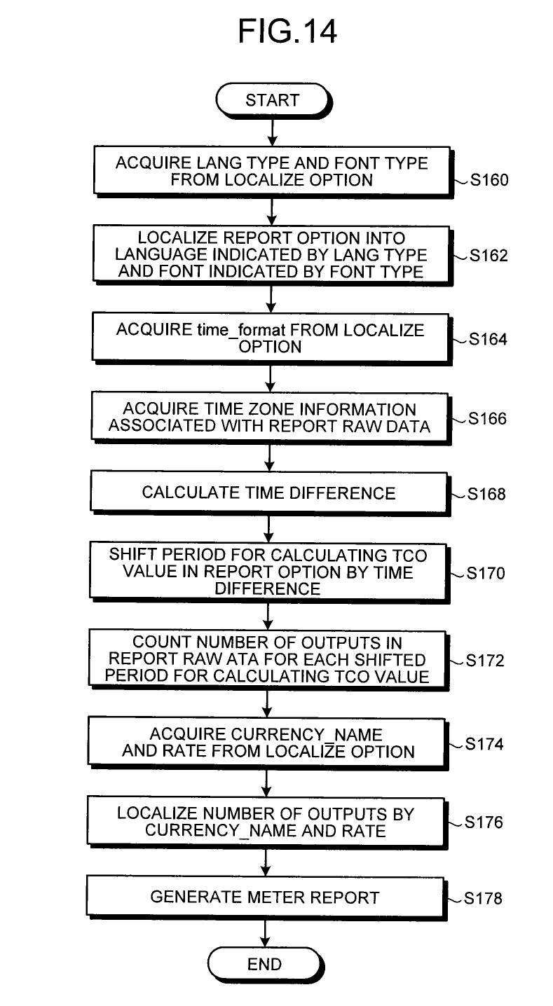

FIG. 14 is a flowchart illustrating a detailed example of generation of a meter report by the information processing apparatus 100 of the first embodiment, and illustrates details of Step S152 in FIG. 13.

First, the report generator 154 acquires a langType (language) and a fontType (font) from the localize option 152 (Step S160).

Subsequently, the report generator 154 localizes the report option 153 into a language indicated by the acquired langType and a font indicated by the acquired fontType (Step S162). At this time, the report generator 154 employs the contents of the report option 153 as they are if the description language of the report option 153 is the language indicated by the langType, and translates the contents of the report option 153 into the language indicated by the langType if the description language of the report option 153 is different from the language indicated by the langType.

Then, the report generator 154 acquires a time_format (time zone) from the localize option 152 (Step S164).

Subsequently, the report generator 154 acquires time zone information associated with the report raw data 123 from the device management information storage unit 130 (Step S166).

Then, the report generator 154 calculates a time difference between the time zone indicated by the time_format and the time zone indicated by the time zone information (Step S168).

Subsequently, the report generator 154 shifts a period for calculating the TCO value in the report option 153 by the calculated time difference (Step S170).

Then, the report generator 154 counts the number of outputs in the report raw data 123 for each shifted period for calculating the TCO value (Step S172).

Subsequently, the report generator 154 acquires a currency_name (currency name) and a rate (currency rate) from the localize option 152 (Step S174).

Then, the report generator 154 localizes the counted number of outputs into a TCO value that is converted to a currency corresponding to the acquired currency_name (Step S176).

Subsequently, the report generator 154 writes the device information and the calculated TCO value in the report raw data 123 in accordance with the display items written in the acquired language, and generates the meter report (Step S178).

As described above, in the first embodiment, it is possible to generate a report localized for a region to which a user belongs, so that it is possible to generate the report by taking into account the characteristics of the region to which the user belongs. Therefore, even when a customer who has introduced an MPS is a global company that globally develops a business and users in various regions view the report, it is possible to easily understand the contents of the report.

For example, according to the first embodiment, the TCO of a device is calculated in the currency used in the region to which a user belongs, so that even when users in various regions view the report, it is possible to easily understand the contents of the report.

In particular, according to the first embodiment, the characteristics of the region to which a user belongs is specified based on the software information on a user terminal used by the user who has sent a request to generate a report; therefore, even if a user is an unregistered user whose user information is not registered, a guest user, or a user using a shared account, it is possible to generate a report by taking into account the characteristics of the region to which the user belongs.

Further, according to the first embodiment, the TCO of a device is calculated by taking into account a time difference between a region in which the device is installed and a region to which the user belongs; therefore, even when users in various regions view the report, it is possible to accurately obtain the TCO of the device.

For example, according to the first embodiment, a report is generated in a language used in the region to which a user belongs, so that even when users in various regions view the report, it is possible to easily understand the contents of the report.

### Second Embodiment

In a second embodiment, an example will be described, in which region information is specified by using network information on a location of a user terminal on a network, instead of using the software information. In the following, a difference from the first embodiment will be mainly described, and components having the same functions as those of the first embodiment will be denoted by the same names and symbols, and explanation thereof will be omitted.

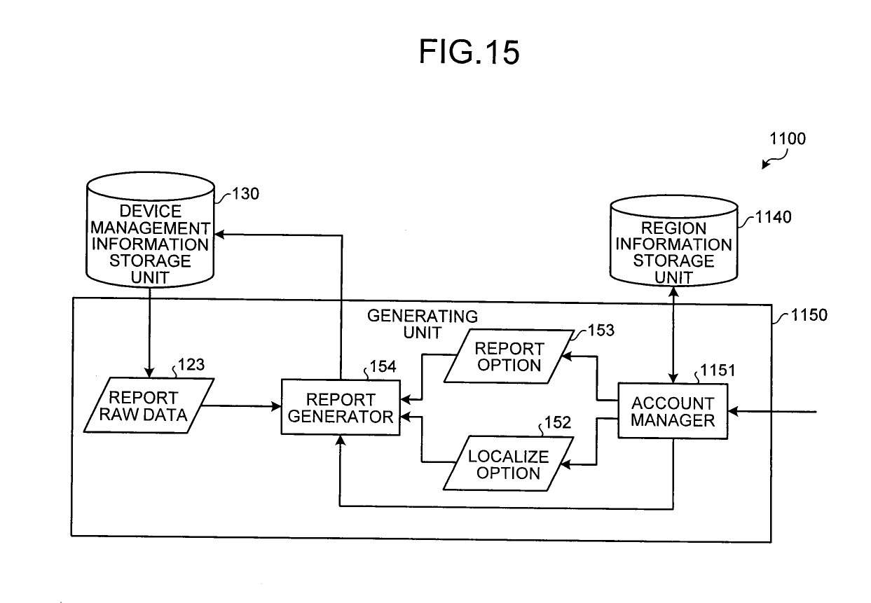

FIG. 15 is a block diagram illustrating an example of detailed configurations of a region information storage unit 1140 and a generating unit 1150 of an information processing apparatus 1100 of the second embodiment. As illustrated in FIG. 15, in the second embodiment, the region information storage unit 1140 and an account manager 1151 of the generating unit 1150 differ from those of the first embodiment.

In the second embodiment, the region information storage unit 1140 stores therein region identification information for identifying a region, language information indicating a language used in the region, font information indicating a font of a language indicated by the language information, currency information indicating a currency used in the region, and time zone information indicating a time zone of the region in an associated manner; however, it is not limited thereto.

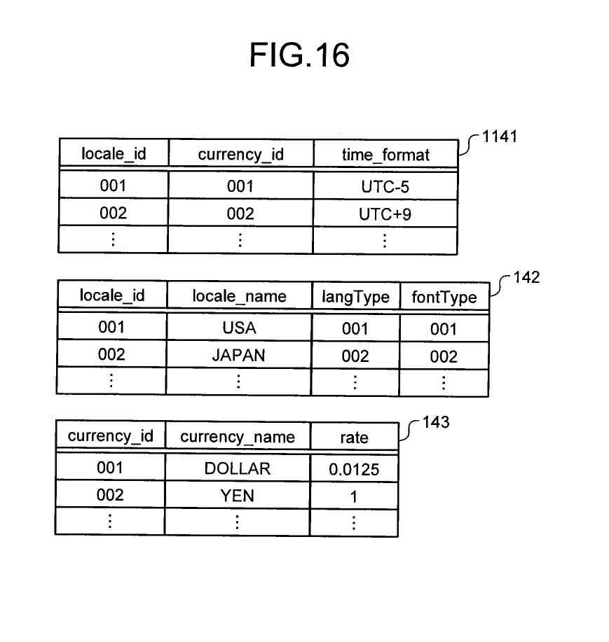

FIG. 16 is a diagram illustrating an example of information stored in the region information storage unit 1140 of the second embodiment. In the example illustrated in FIG. 16, the region information storage unit 1140 stores therein a main table 1141, the locale table 142, and the currency table 143.

The main table 1141 is a table containing, for each region, a locale_id indicating an ID of local information on the region, a currency_id indicating an ID of currency information on the region, and a time_format (an example of the time zone information) of the region to which the user belongs, in an associated manner. The locale table 142 and the currency table 143 are the same as those of the first embodiment, and therefore, explanation thereof will be omitted.

Referring back to FIG. 15, in the second embodiment, the account manager 1151 acquires network information on a location of the user terminal 50 on the network from the user terminal 50 that has sent a generation request. In the second embodiment, an example will be described in which the network information is an IP address of the user terminal 50; however, it is not limited thereto.

The account manager 1151, upon acquiring the network information, specifies region information on the region in which the user using the user terminal 50 is located on the basis of the network information. Specifically, the account manager 1151 specifies a region in which the IP address is used from the IP address serving as the network information, and specifies the region identification information. For example, the account manager 1151 may specify the region identification information from the IP address by using information, in which the IP address is associated with the region identification information on the region where the IP address is used.

Further, the account manager 1151, by referring to the region information storage unit 1140, specifies the currency information, the language information, and the time zone information associated with the specified region identification information, and specifies the font information associated with the specified language information. Specifically, the account manager 1151, by using the specified region identification information, generates a query to acquire currency information, language information, and time zone information on the region indicated by the region identification information and to acquire font information on a language indicated by the language information, and issues the query to the region information storage unit 1140 to specify (acquire) the currency information, the language information, the time zone information, and the font information.

Then, the account manager 1151 employs the region information containing the region identification information, the language information, the time zone information, the currency information, and the font information specified as above, as the region information on the region to which the user using the user terminal 50 belongs, and employs the region information as the localize option 152.

For example, it is assumed that the region information storage unit 1140 stores therein the tables as illustrated in FIG. 16, and the account manager 1151 specifies a region name of “USA” from the network information acquired from the user terminal 50. In this case, the account manager 1151 issues a query generated by using the region name of “USA” to the region information storage unit 1140, and specifies (acquires) a currency name of “DOLLAR”, a rate of “0.0125”, a language of “001 (English)”, a time zone of “UTC-5”, and a font of “001 (century)”. Then, the account manager 1151 employs the region information containing the specified information as the localize option 152 as illustrated in FIG. 6.

For another example, it is assumed that the region information storage unit 1140 stores therein the tables as illustrated in FIG. 16, and the account manager 1151 specifies a region name of “JAPAN” from the network information acquired from the user terminal 50. In this case, the account manager 1151 issues a query generated by using the region name of “JAPAN” to the region information storage unit 1140, and specifies (acquires) a currency name of “YEN”, a rate of “1”, a language of “002 (Japanese)”, a time zone of “UTC+9”, and a font of “002 (MS Gothic)”. Then, the account manager 1151 employs the region information containing the specified information as the localize option 152 as illustrated in FIG. 7.

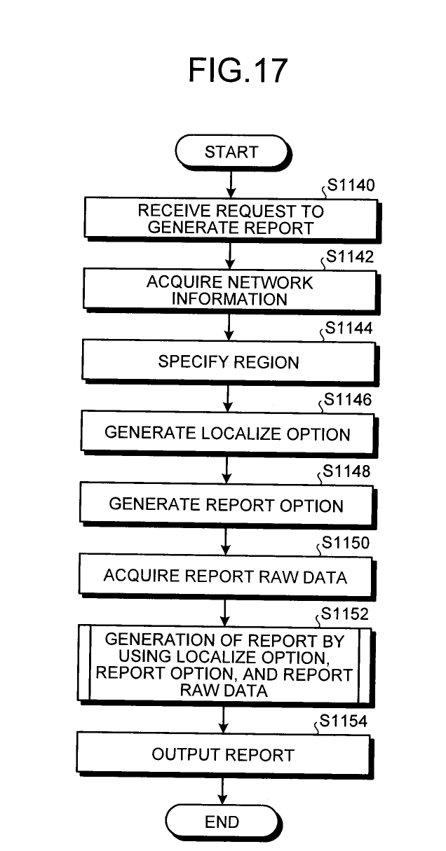

FIG. 17 is a flowchart illustrating an example of a meter report generation process performed by the information processing apparatus 1100 of the second embodiment.

First, upon receiving a request to generate a meter report from the user terminal 50 (Step S1140), the account manager 1151 acquires network information from the user terminal 50 (Step S1142).

Subsequently, the account manager 1151 specifies region identification information by using the acquired network information, generates a query to acquire currency information, language information, and time zone information on a region indicated by the region identification information and to acquire font information on a language indicated by the language information by using the specified region identification information, issues the query to the region information storage unit 1140, and specifies (acquires) the currency information and the font information to specify the region information (Step S1144).

Subsequent processes from Step S1146 to S1154 are the same as the processes from Step S146 to S154 in the flowchart illustrated in FIG. 13, and therefore, explanation thereof will be omitted.

As described above, according to the second embodiment, the characteristics of a region to which a user belongs is specified on the basis of the network information on a user terminal used by the user who has sent a request to generate a report; therefore, even if a user is an unregistered user whose user information is not registered, a guest user, or a user using a shared account, it is possible to generate a report by taking into account the characteristics of the region to which the user belongs.

In particular, the second embodiment is more preferable when a user carrying a user terminal travels on business to a region different from the region to which the user belongs, and shows a report to customers in the different region. For example, a case will be described below in which a Japanese user carrying a user terminal in which a Japanese OS is installed shows a report to customers in the United States of America. In this case, in the method of the first embodiment, a report is generated in Japanese, so that the report is not preferable as a report to be viewed by the customers in the United States of America. However, in the method of the second embodiment, a report is generated in English, so that the report is preferable as a report to be viewed by the customers in the United States of America.

Hardware Configuration

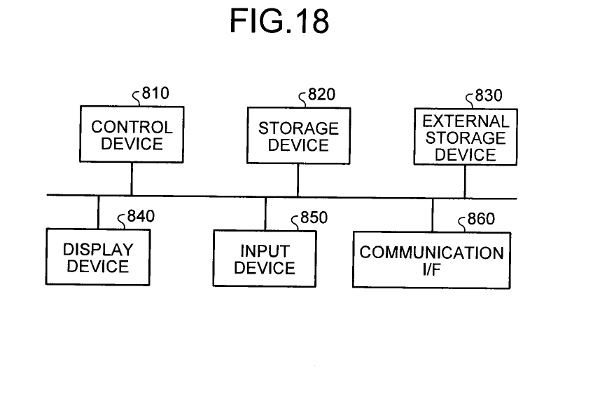

FIG. 18 is a diagram illustrating an example of a hardware configuration of the information processing apparatus of each of the embodiments. The information processing apparatus of each of the embodiments includes a control device 810, such as a CPU, a storage device 820, such as a ROM or a RAM, an external storage device 830, such as an HDD, a display device 840, such as a display, an input device 850, such as a keyboard or a mouse, and a communication interface 860, and has a hardware configuration using a normal computer.

A program executed by the information processing apparatus of each of the embodiments is provided by being stored in a computer-readable storage medium, such as a CD-ROM, CD-R, a memory card, a digital versatile disk (DVD), or a flexible disk (FD), in a computer-installable or a computer-executable file format.

Further, the program executed by the information processing apparatus of each of the embodiments may be stored in a computer connected to a network, such as the Internet, and may be provided by being downloaded via the network. Furthermore, the program executed by the information processing apparatus of each of the embodiments may be provided or distributed via a network, such as the Internet. Moreover, the program executed by the information processing apparatus of each of the embodiments may be provided by being incorporated in a ROM or the like in advance.

The program executed by the information processing apparatus of each of the embodiments has a module structure to implement the above described units on a computer. As actual hardware, the CPU reads a report generation program from the HDD onto the RAM and executes the program, so that each of the units is implemented on the computer.

The present invention is not limited to the embodiments as described above, but may be modified in various forms.

Modification

For example, in the above described embodiments, the image forming device has been described by way of example; however, the present invention is not limited thereto. As described earlier, the image forming device may be a terminal device, such as a PC, or may be various electronic devices, such as a projector, a camera, an air conditioner, a refrigerator, a fluorescent light, an automatic vending machine, or a handheld terminal.

According to an embodiment of the present invention, it is possible to generate a report by taking into account the characteristics of a region to which a user belongs, regardless of whether user information is registered or not.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a software information acquiring unit that acquires, from a terminal device, software information on software running on the terminal device;
a specifying unit that specifies region information on a region to which a user using the terminal device belongs, on the basis of the software information;
a device management information acquiring unit that acquires device management information on usage of a device;
a generating unit that generates a report on the basis of the region information and the device management information; and
an output unit that outputs the report to the terminal device.

2. The information processing apparatus according to claim 1, further comprising:
a generation request receiving unit that receives a generation request to generate the report, wherein
the generating unit acquires display information on the report from the generation request, and generates, as the report, a report in which contents of the device management information and the display information are configured for the region indicated by the region information.

3. The information processing apparatus according to claim 2, wherein
the display information is represented by text data,
at least a part of the device management information is represented by numerical data indicating the usage of the device,
the region information includes region identification information for identifying the region, language information for identifying a language used in the region, and currency information indicating a currency used in the region,
the information processing apparatus further comprises:
a region information storage unit that stores therein the region identification information and the currency information in an associated manner, wherein
the specifying unit specifies the region identification information and the language information by using the software information, and specifies the currency information associated with the specified region identification information by referring to the region information storage unit, and
the generating unit generates, as the report, a report in which numerical data indicated by the device management information is converted to the currency indicated by the currency information such that a cost for the device is calculated in the currency, and in which the display information is described in the language indicated by the language information.

4. The information processing apparatus according to claim 3, wherein
the region information further includes font information indicating a font of the language indicated by the language information,
the region information storage unit further stores therein the language information and the font information in an associated manner,
the specifying unit further specifies the font information associated with the specified language information by referring to the region information storage unit, and
the generating unit generates a report in which the display information is described in the language indicated by the language information and in the font indicated by the font information.

5. The information processing apparatus according to claim 3, further comprising:
a period receiving unit that receives input of a period for calculating the cost, wherein
the region information further includes time zone information indicating a time zone of the region,
the specifying unit further specifies the time zone information by using the software information,
at least a part of the device management information is represented by numerical data indicating the usage of the device for each day and each time,
the device management information acquiring unit corrects the period received by the period receiving unit to a corrected period by using the time zone indicated by the time zone information and a time zone of a region in which the device is installed, and acquires the device management information in the corrected period, and
the generating unit generates, as the report, a report in which the cost of the device for the corrected period is calculated.

6. The information processing apparatus according to claim 1, wherein the report is a report on use of the device.

7. An information processing apparatus connected to a terminal device via a network, the information processing apparatus comprising:
a network information acquiring unit that acquires, from the terminal device, network information on a location of the terminal device on the network;
a specifying unit that specifies region information on a region to which a user using the terminal device is located on the basis of the network information;
a device management information acquiring unit that acquires device management information on usage of a device;
a generating unit that generates a report on the basis of the region information and the device management information; and
an output unit that outputs the report to the terminal device.

8. The information processing apparatus according to claim 7, further comprising:
a generation request receiving unit that receives a generation request to generate the report, wherein
the generating unit acquires display information on the report from the generation request, and generates, as the report, a report in which contents of the device management information and the display information are configured for the region indicated by the region information.

9. The information processing apparatus according to claim 8, wherein
the display information is represented by text data,
at least a part of the device management information is represented by numerical data indicating the usage of the device,
the region information includes region identification information for identifying the region, language information for identifying a language used in the region, and currency information indicating a currency used in the region,
the information processing apparatus further comprises:
a region information storage unit that stores therein the region identification information, the language information, and the currency information in an associated manner, wherein
the specifying unit specifies the region identification information by using the network information, and specifies the language information and the currency information associated with the specified region identification information by referring to the region information storage unit, and
the generating unit generates, as the report, a report in which numerical data indicated by the device management information is converted to the currency indicated by the currency information such that a cost for the device is calculated in the currency, and in which the display information is described in the language indicated by the language information.

10. The information processing apparatus according to claim 9, wherein
the region information further includes font information indicating a font of the language indicated by the language information,
the region information storage unit further stores therein the font information in an associated manner,
the specifying unit further specifies the font information associated with the specified language information by referring to the region information storage unit, and
the generating unit generates a report in which the display information is described in the language indicated by the language information and in the font indicated by the font information.

11. The information processing apparatus according to claim 9, further comprising:
a period receiving unit that receives input of a period for calculating the cost, wherein
the region information further includes time zone information indicating a time zone of the region,
the region information storage unit further stores therein the time zone information in an associated manner,
the specifying unit further specifies the time zone information associated with the specified region identification information by referring to the region information storage unit,
at least a part of the device management information is represented by numerical data indicating the usage of the device for each day and each time,
the device management information acquiring unit corrects the period received by the period receiving unit to a corrected period by using the time zone indicated by the time zone information and a time zone of a region in which the device is installed, and acquires the device management information in the corrected period, and
the generating unit generates, as the report, a report in which the cost of the device for the corrected period is calculated.

12. The information processing apparatus according to claim 7, wherein the report is a report on use of the device.

13. A report generating method comprising:
acquiring, from a terminal device, software information on software running on the terminal device;
specifying region information on a region to which a user using the terminal device belongs, on the basis of the software information;
acquiring device management information on usage of a device;
generating a report on the basis of the region information and the device management information; and
outputting the report to the terminal device.

14. A report generating method comprising:
acquiring, from a terminal device, network information on a location of the terminal device on a network;
specifying region information on a region to which a user using the terminal device is located on the basis of the network information;
acquiring device management information on usage of a device;
generating a report on the basis of the region information and the device management information; and
outputting the report to the terminal device.
